(19) United States
(12) Patent Application Publication
(10) Pub. No.: US 2010/0049705 A1
(43) Pub. Date: Feb. 25, 2010

(54) DOCUMENT SEARCHING DEVICE, DOCUMENT SEARCHING METHOD, AND DOCUMENT SEARCHING PROGRAM

(75) Inventors: Shingo Ochi, Tokushima-shi (JP); Takanori Hino, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: Justsystems Corporation, Tokushima-shi (JP)

(21) Appl. No.: 12/443,108

(22) PCT Filed: Sep. 28, 2007
(86) PCT No.: PCT/JP2007/001063

§ 371 Date: Mar. 26, 2009

(30) Foreign Application Priority Data
Sep. 29, 2006 (JP) 2006-267886

(51) Int. Cl. G06F 17/30

(52) U.S. Cl. 707/5; 707/E17.014; 707/E17.008

(57) ABSTRACT

The present invention relates to a document search apparatus for searching a predetermined corpus for a document file whose content is related to text for searching. The apparatus stores index information that indicates the position in a document and the position in a morpheme for a respective gram. Upon the receipt of the input of text for searching, from a user, the document search apparatus extracts a morpheme and a gram. Then, upon the indexing of the rarity of the morpheme in the corpus and the detection of a document file that contains the morpheme, the number of times such a morpheme appears in the document file is counted as an appearance frequency. From the estimate number and the appearance frequency regarding the morpheme, the relevance of the contents between the text for searching and the document file is indexed as a relevance score.

### TECHNICAL FIELD

The present invention relates to document processing techniques, and particularly to techniques for searching for document files whose contents are related to text provided for searching.

### BACKGROUND ART

With the growing use of computers and the progress of the networking techniques, there has been an increase in electronic information exchange via network. In this background, a lot of paperwork that is conventionally paper-based has been replaced by network-based processing. The progress of digitalization and network techniques has drastically lowered the cost for information acquisition. In this circumstance, document search techniques for searching for document files (hereinafter referred to as “related documents” or “related document files”) whose contents are related to text (hereinafter referred to as “text for searching”) entered by users have attracted attention. Typical examples of document search techniques based on natural languages are morphological analysis and Ngram analysis.

[Patent document 1] JP 2005-99972

### DISCLOSURE OF INVENTION

### Technical Problem

Although descriptions are made for a natural-language process for a Japanese language in the following, the fundamental principle of the present invention can be applied to other languages including English. In morphological analysis, text is divided into semantic units called a morpheme in accordance with predetermined rules. For example, in the case of Japanese text that indicates “the president of the United States of America (note that the text is represented by a total of eleven letters according to three types of characters in Japanese: a(katakana)/me(katakana)/ri(katakana)/ka(katakana)/ga(Chinese character)/syu(Chinese character)/koku(Chinese character)/no(hiragana)/dai(Chinese character)/tou(Chinese character)/ryou(Chinese character), hereinafter katakana is referred to as k, hiragana as h, and Chinese character as c, respectively)”, based on parts of speech including a noun and a particle, the text is divided down into three morphemes as follows: “the United States of America (a(k)/me(k)/ri(k)/ka(k)/ga(c)/syu(c)/koku(c)); of (no(h)); and the president (dai(c)/tou(c)/ryou(c))”. The relevance of contents between the text for searching and the document files are then determined in accordance with the extent to which the document file contains the same morphemes as those in the text for searching. Since the search and determination process is based on a character string referred to as a morpheme that has a meaning, the advantage is to be able to minimize the chance of misjudging a non-related document as a related document. On the negative side, the chance of determining a related document as a non-related document is higher. For example, in a document search for a morpheme “the United States of America (a(k)/me(k)/ri(k)/ka(k)/ga(c)/syu(c)/koku(c))”, a document file “In America, . . . (note that the text is rendered in Japanese as a(k)/me(k)/ri(k)/ka(k)/de(h)/wa(h)/pause mark)” is not to be detected. This is due to the reason that although the text for searching and the document file have “contents related to America” in common, the morphemes do not match with each other since one is “the United States of America (a(k)/me(k)/ri(k)/ka(k)/ga(c)/syu(c)/koku(c))” and the other is “America (a(k)/me(k)/ri(k)/ka(k)).

In Ngram analysis, text is divided by a character string unit called a gram, which has a predetermined length. In the case of text “the president of the United States of America (a(k)/me(k)/ri(k)/ka(k)/ga(c)/syu(c)/koku(c)/no(h)/dai(c)/tou (c)/ryou(c))”, multiple grams are detected as follows: “(a(k)/me(k)/ri(k); me(k)/ri(k)/ka(k); . . . ; and (dai(c)/tou(c)/ryou(c))”. A gram is not always a unit that has a meaning. Therefore, even in the case of the document file “In America, . . . ”, which is mentioned earlier, its grams such as “a(k)/me(k)/ri(k)” and “me(k)/ri(k)/ka(k)” match those of the text for searching. (Note that the grams such as “a/me/ri” and “me/ri/ka” are not words that have particular meaning in Japanese. The Japanese text indicating “the president of the United States of America” is merely divided into blocks each comprising three letters based on a Japanese language.) The Ngram analysis has an advantage of minimizing the chance of misjudging a related document as a non-related document, in other words, the chance of drop-out is low. On the negative side, the chance of mistakenly determining a non-related document as a related document is higher. For example, even a document file such as “merica-essence (note that the text is represented by a total of eight letters in Japanese “me(k)/ri(k)/ka(k)/e(k)/assimilated sound symbol/se(k)/n(k)/su(k)”) is . . . ”, which does not have much relevance to the text for searching, can be detected due to the match of a gram “me(k)/ri(k)/ka(k)”.

As described above, the advantages and disadvantages of the morphological analysis and those of the Ngram analysis are inversely related to each other. It therefore has come to the inventor's attention that document search having higher accuracy than conventional search may be achieved by combining two types of analysis methods using “semantic unit” and “character string unit”.

In this background, a general purpose of the present invention is to provide a technology for improving the accuracy of document search based on a natural language.

### Means for Solving the Problem

An aspect of the present invention relates to document searching apparatus for searching for document files whose contents are related to text for searching. The apparatus stores index information of a gram, a document file that contains the gram, and the position of the gram in a morpheme of the document file in association with each gram. Upon the receipt of the input of text for searching, the apparatus extracts at least one morpheme for searching and further extracts at least one gram. The number of document files in which the position of a specific gram in a morpheme matches the position of a specific gram in a given morpheme for searching is identified as an estimate number that indicates the rarity of the morpheme for searching. Then, upon the detection of a document file that contains the morpheme for searching, the number of times the morpheme for searching appears in the document file is counted as an appearance frequency. From the estimate number and the appearance frequency regarding the morpheme for searching, the relevance of the contents between the text for searching and the document file is indexed as a relevance score.

Another aspect of the present invention also relates to document search apparatus for searching for document files whose contents are related to text for searching. The apparatus stores index information of a gram, a document file that contains the gram, and the position of the gram in a morpheme of the document file in association with each gram.

Upon the receipt of the input of text for searching, the apparatus extracts at least one morpheme for searching and at least one gram. Based on the appearance rates of multiple grams at the beginning and at the end of the morpheme, which are contained in a given morpheme for searching the morpheme for searching is separated into multiple partial morphemes. Then, upon the detection of a document file that contains a partial morpheme, the number the partial morpheme appears in the document file is counted as an appearance frequency. From the appearance frequency counted for a partial morpheme and the position of the partial morpheme in the morpheme for searching, the relevance in terms of content between the text for searching and the document file is indexed as a relevance score.

Optional combinations of the aforementioned constituent elements, or implementations of the invention in the form of methods, systems, programs, and recording mediums may also be practiced as additional modes of the present invention.

### ADVANTAGEOUS EFFECTS

The present invention provides document search based on a natural language with improved accuracy.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a schematic diagram that illustrates the overview of a process by a document search apparatus;

FIG. 2 is a data structure diagram of an index-storing unit;

FIG. 3 is a flowchart that shows a process of generating index information;

FIG. 4 is a functional block diagram of the document search apparatus;

FIG. 5 is a flowchart that shows a processing process of identifying a related document file;

FIG. 6 is a view that shows the appearance mode of each gram included in an archimorpheme “soccerworldcup” in a corpus;

FIG. 7 is a view that shows the appearance rate of each gram included in an archimorpheme “soccerworldcup” in a corpus;

FIG. 8 is a flowchart that shows the processing process of a first calculation method for a relevance score calculation process in S32 of FIG. 5;

FIG. 9 is a view that shows the relation between the phrase probability and the intermediate value of each partial morpheme included in the archimorpheme “soccerworldcup”; and

FIG. 10 is a flowchart that shows the processing process of a second calculation method for a relevance score calculation process in S32 of FIG. 5.

### EXPLANATION OF REFERENCE

100 document search apparatus
110 user interface processor
112 input unit
114 display unit
116 text-for-searching acquisition unit
120 data processor
122 analysis unit
124 statistic unit
126 search unit
128 relevance-score calculation unit
130 index-storing unit
132 gram-name field
134 document-ID field
136 intra-document position field
138 intra-morpheme position field
140 appearance-rate calculation unit
142 phrase-probability calculation unit
144 morpheme extraction unit
146 gram extraction unit
148 morpheme division unit
150 estimate-number identification unit
152 appearance-frequency counting unit
200 document database

### BEST MODE FOR CARRYING OUT THE INVENTION

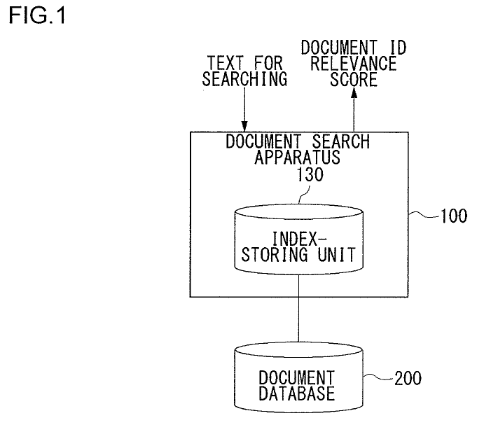

FIG. 1 is a schematic diagram that illustrates the overview of a process by a document search apparatus 100.

Upon the input of text for searching by a user, the document search apparatus 100 searches for a document file, whose contents are related to the text for searching, in a document database 200. The text for searching is a character string that has a certain meaning and it may be a natural-language sentence or a keyword. A document file of the document database 200 may be a structured file such as an XML (eXtensible Markup Language) document and an XHTML (eXtensible HyperText Markup Language) document, or it may be just a text file. It is assumed that the document file to be searched for is an XML file in the exemplary embodiment. A group of document files to be searched for, which is stored in the document database 200, is hereinafter referred to as a “corpus”.

An index-storing unit 130 of the document search apparatus 100 stores index information for searching for each document file. Detailed description will be made later regarding the index information. The document search apparatus 100 detects a document file in a corpus based on text for searching and index information and then indexes the relevance in terms of content to the text for searching as a “relevance score”. The document search apparatus 100 displays a document ID and a relevance score of a document file having the relevance score ranked, for example, 20th or higher. As described, a user of the document search apparatus 100 can find a document file having high relevance in terms of content to an arbitrary text for searching.

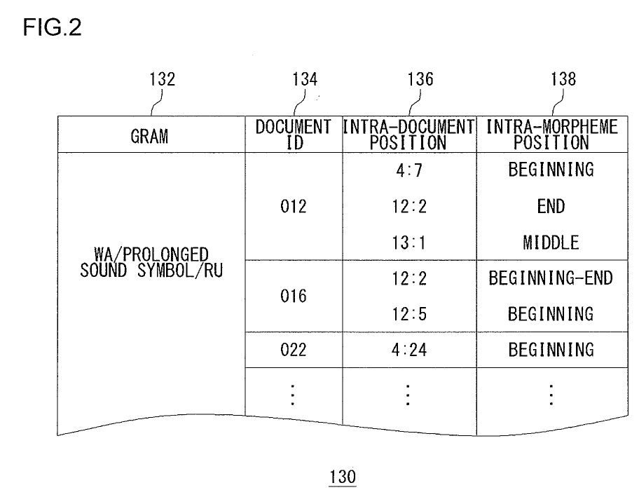

FIG. 2 is a data structure diagram of an index-storing unit 130.

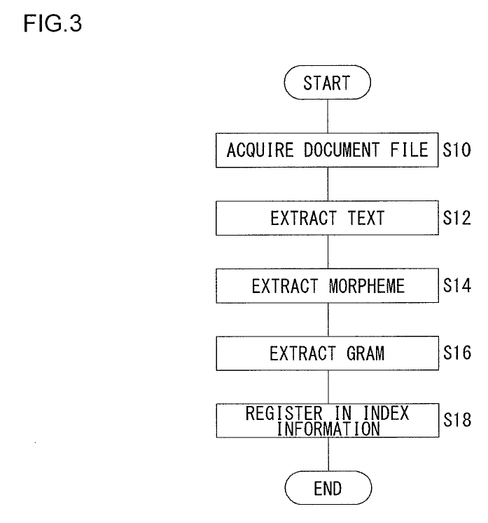

The index information for the corpus is necessary for a document-search process in the exemplary embodiment to be performed. Detailed description will be made later, in relation to FIG. 3, regarding the generation of the index information. First, the data structure of the index information is described in detail. The index information contains five items: a gram-name field 132; a document-ID field 134; an intra-document position field 136; and an intra-morpheme position field 138.

The gram-name field 132 shows the name of a gram. A gram is a sequence of a predetermined number of letters in a series. The figure shows the index information for a gram of three-katakana-character string “wa(k)/prolonged sound symbol/ru(k) (note that the gram is represented by three letters in Japanese)”. The document-ID field 134 shows the document ID of a document file containing a corresponding gram. The document ID is an ID for uniquely identifying a document file in a corpus. According to the figure, the gram “wa(k)/prolonged sound symbol/ru(k)” is contained in multiple document files having documents ID's “012”, “016”, “022”. However, in what context the gram “wa(k)/prolonged sound symbol/ru(k)” is used in each document file is not known directly from the index information.

The intra-document position field 136 shows the position of the corresponding gram in each document file in the following form: “node number: offset”. Such a position of a gram in a document is referred to as a “position in a document”. For example, in a document file “ . . . <node> In the World Series in year 2006 (note that the text is rendered in Japanese as “2/0/0/6/nen(c)/no(h)/wa(k)/prolonged sound symbol/ru(k)/do(k)/si(k)/ri(k)/prolonged sound symbol/zu(k)/de(h)/wa(h)/,”), . . . ”, it is assumed that the <node> tag is the forth tag in the document file. In this document file, a gram “wa(k)/prolonged sound symbol/ru(k)” appears at the seventh letter (when rendered in Japanese) in the <node> tag element. Therefore, the position in the document is “4:7”.

The intra-morpheme position field 138 shows the position of the corresponding gram in a morpheme by using four types of a “position in a morpheme”: “beginning”; “end”; “middle”; and “beginning-end”. It is assumed that the aforementioned text is divided into morphemes as follows: “(2006):(nen): (no):(wa/prolonged sound symbol/ru/do/si/ri/prolonged sound symbol/zu): (de/wa): (,): . . . ”. The gram “wa(k)/prolonged sound symbol/ru(k)” is located in the beginning of the morpheme “World Series (wa/prolonged sound symbol/ru/do/si/ri/prolonged sound symbol/zu)”. Thus, the position in the morpheme is “beginning”. If the gram “wa(k)/prolonged sound symbol/ru(k)” is contained in a morpheme “Renoir (note that the text is rendered in five letters in Japanese as “ru(k)/no(k)/wa(k)/prolonged sound symbol/ru(k)”) or in a morpheme “Cote d'Ivoire (note that the text is rendered in eight letters in Japanese as “ko(k)/prolonged sound symbol/to(k)/zi(k)/bo(k)/wa(k)/prolonged sound symbol/ru(k)”)”, the position in the morpheme is “end”. If the gram “wa(k)/prolonged sound symbol/ru(k)” is contained in a morpheme “Kowalski (note that the text is rendered in seven letters in Japanese as “ko(k)/wa(k)/prolonged sound symbol/ru(k)/su(k)/ki(k)/prolonged sound symbol”) or in a morpheme “soccerworld (note that the text is rendered in Japanese as “sa(k)/assimilated sound symbol/prolonged sound symbol/ka(k)/prolonged sound symbol/wa(k)/prolonged sound symbol/ru(k)/do(k)”)”, the position in the morpheme is “middle”. If the morpheme itself is “wa(k)/prolonged sound symbol/ru(k)”, the position of the gram “wa(k)/prolonged sound symbol/ru(k)” in the morpheme is “beginning-end”.

The index-storing unit 130 stores index information for each gram detected in the corpus. In the research conducted by the inventors, about 540 thousand types of grams were detected in 230 thousand documents (about 250 MB). In such a case, index information, as shown in the figure, is prepared for each gram of the 540 thousand types of grams.

The number of the letters that constitute a gram (hereinafter, referred to as “N number”) is not limited to be three as in “wa/prolonged sound symbol/ru”. The larger the N number becomes, the higher precision that is used for determining the relevance between text for searching and a document file becomes. As the precision increases, the chance of mistakenly determining a non-related document as a related document decreases. For example, in the case of searching for a related document file for “Armstrong Cannon (note that the text is represented by a total of nine letters in Japanese: “a(k)/prolonged sound symbol/mu(k)/su(k)/to(k)/ro(k)/n(k)/gu(k)/hou(c)”), searching for a document that includes a one-letter gram “a(k)” will result in the detection of a large amount of non-related documents. However, in the case of searching for a document file containing an eight-letter gram “a(k)/prolonged sound symbol/mu(k)/su(k)/to(k)/ro(k)/n(k)/gu(k)”, such a noise (non-related document) can be reduced. On the negative side, as the N number increases, the type of the gram also increases, resulting in the increased amount of index information. Also, recall decreases. As the recall increases, the chance of missing the detection of the related documents is lowered.

In order to obtain an optimal N number, the inventor performed a research, in a corpus, on the number of letters in a series with respect to each character type. The respective number of letters in a series, which appeared the most, is shown in the following.

Chinese characters: 1-2 letters

hiragana: 1-3 letters (Note that one letter is often the result of searching for a particle such as “no, wa, wo”.) one letter is often

(Note that “no”, “wa”, and “wo” are particles that are used to put words together in Japanese.)

katakana: 2-4 letters

alphanumeric characters: 3-6 letters

Based on the above aspect, the N number of a gram is set in accordance with respective character type as follows.

Chinese character: 2, hiragana: 3, katakana: 4, alphanumeric character: 4, and connected characters: 2

For example, in the case of a morpheme “the United States of America (a(k)/me(k)/ri(k)/ka(k)/ga(c)/syu(c)/koku(c))”, there are five grams that can be extracted: “a(k)/me(k)/ri(k); me(k)/ri(k)/ka(k); ka(k)/ga(c); ga(c)/syu(c); and syu(c)/koku(c)”. The gram “ka(k)/ga(c)” is the gram that connects katakana and Chinese characters. Such a gram is a gram of connected characters.

FIG. 3 is a flowchart that shows a process of generating index information.

When a document file is newly registered in the document database 200, a gram that is contained in the document file is registered in index information. The document search apparatus 100 first acquires a new document file (S10) and then extracts a text portion from the document file (S12). Then the text is divided into morphemes (S14), and the morphemes are further divided into grams (S16). Finally, the position, in the document and in the morpheme, of the gram extracted is registered in index information.

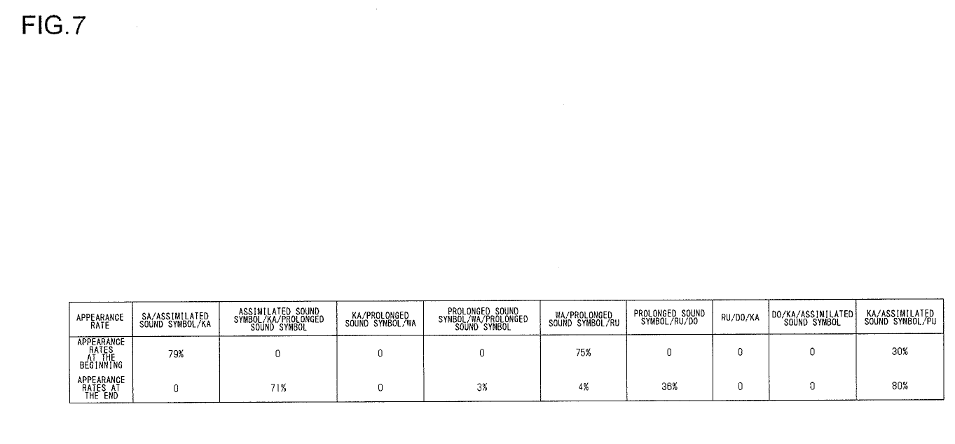

When a document file is deleted from a corpus, a gram in the document file to be deleted is deleted from index information. As described above, the index information changes in accordance with the change in the corpus. The morpheme that is extracted in S14 may be further divided into smaller morphemes by a morpheme division process that is described in detail hereinafter. The morpheme division process will be described in detail in association with FIG. 7.

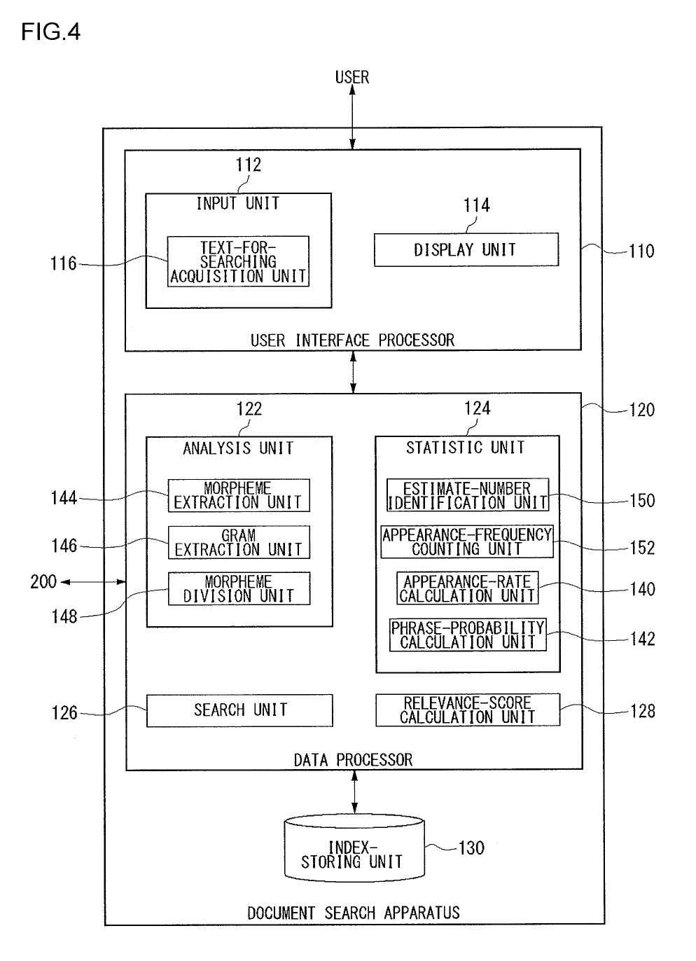

FIG. 4 is a functional block diagram of a document processing apparatus 100.

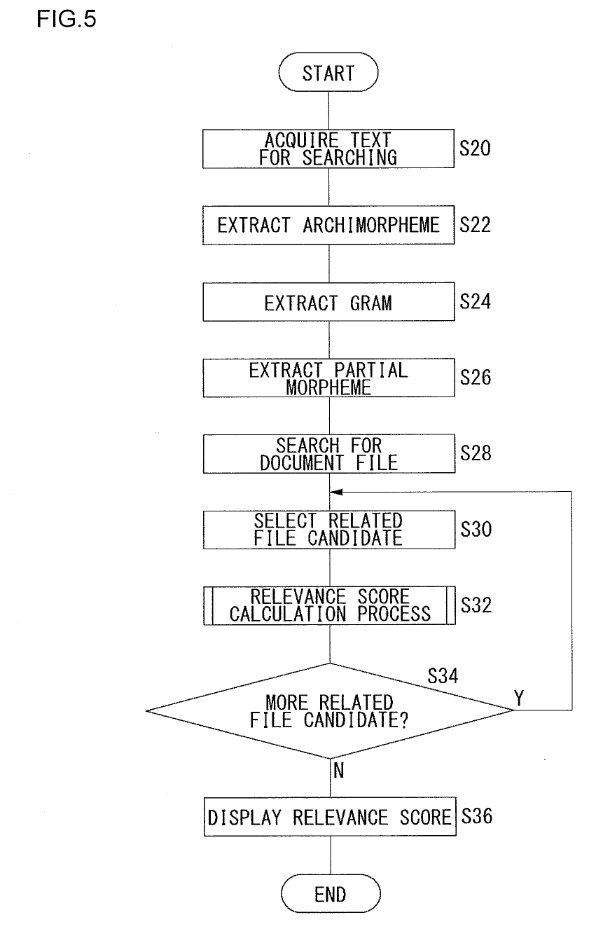

The blocks shown are implemented in hardware by any CPU of a computer, other elements, and mechanical devices, and in software by a computer program or the like. FIG. 5 depicts functional blocks implemented by the cooperation of hardware and software. Therefore, it will be obvious to those skilled in the art that the functional blocks may be implemented in a variety of manners by a combination of hardware and software.

The document search apparatus 100 is provided with a user interface processor 110, a data processor 120, and an index-storing unit 130.

The user interface processor 110 is in charge of the process with regard to a general user interface such as processing the input from a user and displaying information to a user. In the exemplary embodiment, an explanation is given on the premise that the user interface service of the document search apparatus 100 is provided by the user interface processor 110. As another example, the user may manipulate the document search apparatus 100 via the internet. In this case, a communication unit (not shown) receives manipulation-instruction information from a user terminal and transmits information on the results of the process performed based on the manipulation instruction.

The data processor 120 performs various data process based on the data acquired from the user interface processor 110 and from the document database 200. The data processor 120 also plays a role of an interface between the user interface processor 110 and the index-storing unit 130.

The user interface processor 110 is provided with an input unit 112 and a display unit 114. The input unit 112 receives input manipulation from a user. The display unit 114 displays all sorts of information to the user. The input unit 112 is provided with a text-for-searching acquisition unit 116 for obtaining text for searching.

The data processor 120 is provided with an analysis unit 122, a statistic unit 124, a search unit 126, and a relevance-score calculation unit 128.

The analysis unit 122 analyzes the document structure of text for searching and a document file. The analysis unit 122 is provided with a morpheme extraction unit 144, a gram extraction unit 146, and a morpheme division unit 148. The morpheme extraction unit 144 extracts at least one morpheme from text. The term “text” refers to text that is extracted from a document file or text for searching. The morpheme extraction unit 144, referring to dictionary data prepared in advance, may extract as a morpheme a word that is registered in the dictionary data or may extract a morpheme according to a part of speech or a character type. The method of extracting a morpheme by the morpheme extraction unit 144 may be the application of a known technique. The gram extraction unit 146 extracts at least one gram from the morpheme extracted by the morpheme extraction unit 144. The morpheme division unit 148 divides the morpheme extracted by the morpheme extraction unit 144 into smaller morphemes. Such a process is referred to as a “morpheme division process”. For example, when the morpheme extraction unit 144 extracts a morpheme “soccerworldcup (note that the word is written as “sa/assimilated sound symbol/ka/prolonged sound symbol/wa/prolonged sound symbol/ru/do/ka/assimilated sound symbol/pu” and is a compound word of three words “soccer (sa/assimilated sound symbol/ka/prolonged sound symbol)”, “world (wa/prolonged sound symbol/ru/do)”, and “cup (ka/assimilated sound symbol/pu)”)”, the morpheme division unit 148 further extracts, from the morpheme, three morphemes “soccer (sa/assimilated sound symbol/ka/prolonged sound symbol)”, “world (wa/prolonged sound symbol/ru/do)”, and “cup (ka/assimilated sound symbol/pu)”. The morpheme division process will hereinafter be described in detail in association with FIG. 7. In distinguishing the morpheme extracted by the morpheme extraction unit 144 from the morpheme extracted by the morpheme division process of the morpheme division unit 148, the former and the latter are hereinafter referred to as an “archimorpheme” and a “partial morpheme”, respectively.

The statistic unit 124 statistically analyzes, for example, the rarity and the appearance frequency of a morpheme and a gram. The statistic unit 124 is provided with an estimate-number identification unit 150, an appearance-frequency counting unit 152, an appearance-rate calculation unit 140, and a phrase-probability calculation unit 142.

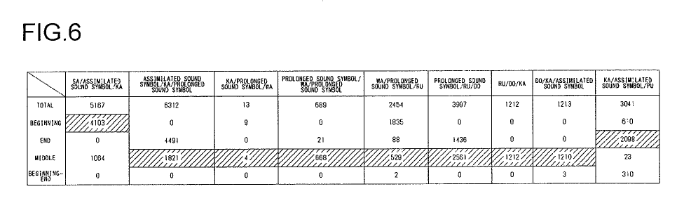

The estimate-number identification unit 150 indexes the rarity of a morpheme in a corpus as an estimate number. The smaller the estimate number is, the higher the rarity becomes. The way of evaluating the estimate number will be described in detail in association with FIG. 6. The appearance-frequency counting unit 152 counts as an appearance frequency the number of times the morpheme contained in the text for searching appears in the document file that is to be searched. With respect to a corpus, the appearance-rate calculation unit 140 calculates the appearance rate, such as rates of appearance at the beginning and at the end, so as to quantify what position in a morpheme a given gram in most likely located. The way of evaluating appearance rate will be described in detail in association with FIG. 7. The phrase-probability calculation unit 142 computes a phrase probability for a morpheme division process. The phrase probability is a numerical value obtained by indexing the probability of a morpheme being used in the proper sense of the word in a corpus. The way of evaluating the phrase probability will be described in detail in association with FIG. 7.

The search unit 126 searches for a document file that contains a morpheme of text for searching in a corpus. The search unit 126 detects, by referring to the index information, a document file that contains a gram in the same order of appearance as the gram in a morpheme. For example, it is assumed that a morpheme “the United States of America (a(k)/me(k)/ri(k)/ka(k)/ga(c)/syu(c)/koku(c))” is detected in the text for searching. Since there are five grams that can be extracted: “a(k)/me(k)/ri(k); me(k)/ri(k)/ka(k); ka(k)/ga(c); ga(c)/syu(c); and syu(c)/koku(c)”, a document file that contains these five grams is to be searched for. The search unit 126 detects a document file that contains all the five grams by referring to the gram-name field 132 and the document-ID field 134 of the index information. Such a document file is referred to as a “mid-stage file candidate”. The search unit 126 then specifies the mid-stage file candidate that contains the five grams in a series by referring to the intra-document position field 136. Such a mid-stage file candidate is a document file that contains the morpheme “the United States of America (a(k)/me(k)/ri(k)/ka(k)/ga(c)/syu(c)/koku(c))”. Such a document file is also referred to as a “related file candidate”.

As described above, the search unit 126 detects, based on a gram, the related file candidate with regard to a morpheme in text for searching. Thus, the search unit 126 can specify the related file candidate by using only the index information without examining the contents of a document file.

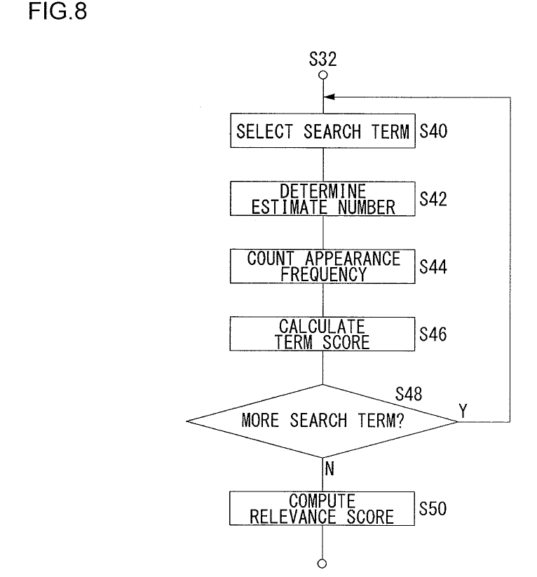

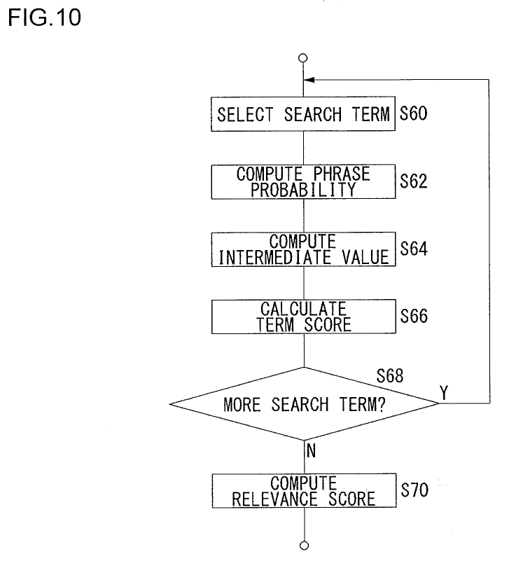

The relevance-score calculation unit 128 computes a relevance score for each related file candidate. The relevance score is a score that indicates the extent of the relevance in terms of content between text for searching and a document file. With regard to the method for computing the relevance score, two types of calculation methods will be described in detail in association with FIGS. 8 and 10.

FIG. 5 is a flowchart that shows a processing process of identifying a related document file.

The text-for-searching acquisition unit 116 first acquires text for searching (S20). As an example, it is assumed that text for searching “As a team that will win 2006 soccer World Cup . . . (note that it is written as “2/0/0/6/nen(c)/no(h)/sa(k)/assimilated sound symbol/ka(k)/prolonged sound symbol/wa(k)/prolonged sound symbol/ru(k)/do(k)/ka(k)/assimilated sound symbol/pu(k)/ni(h)/yu(c)/syo(c)/su(h)/ru(h)/ti(k)/prolonged sound symbol/mu(k)/to(h)/si(h)/te(h) . . . ”)” is input. The morpheme extraction unit 144 extracts an archimorpheme from the text for searching (S22). It is assumed multiple archimorphemes are extracted as follows: “(2006); (nen(c)); (no(h)); soccerworldcup (sa(k)/assimilated sound symbol/ka(k)/prolonged sound symbol/wa(k)/prolonged sound symbol/ru(k)/do(k)/ka(k)/assimilated sound symbol/pu(k)); (ni(h)); (yu(c)/syo(c)); (su(h)/ru(h)); (ti(k)/prolonged sound symbol/mu(k)); (to(h)/si(h)/te(h)) . . . ”. The process shown in the following is performed on each archimorpheme. However, to simplify the explanation, the explanation is made on the archimorpheme “soccerworldcup (sa(k)/assimilated sound symbol/ka(k)/prolonged sound symbol/wa(k)/prolonged sound symbol/ru(k)/do(k)/ka(k)/assimilated sound symbol/pu(k))”.

The gram extraction unit 146 extracts at least one gram from the archimorpheme (S24). In the case of the morpheme “soccerworldcup (“sa/assimilated sound symbol/ka/prolonged sound symbol/wa/prolonged sound symbol/ru/do/ka/assimilated sound symbol/pu”), a total of nine grams are extracted as follows: “sa/assimilated sound symbol/ka”; “assimilated sound symbol/ka/prolonged sound symbol”; “ka/prolonged sound symbol/wa”; “prolonged sound symbol/wa/prolonged sound symbol”; “wa/prolonged sound symbol/ru”; “prolonged sound symbol/ru/do”; “ru/do/ka”; “do/ka/assimilated sound symbol”; and “ka/assimilated sound symbol/pu”. The morpheme division unit 148 then extracts partial morphemes “soccer (sa/assimilated sound symbol/ka/prolonged sound symbol)”, “world (wa/prolonged sound symbol/ru/do)”, and “cup (ka/assimilated sound symbol/pu)” from the archimorpheme “soccerworldcup (“sa/assimilated sound symbol/ka/prolonged sound symbol/wa/prolonged sound symbol/ru/do/ka/assimilated sound symbol/pu”)”. More specifically, based on the appearance rates, at the beginning and at the end of the morpheme, of a gram contained in a morpheme, the morpheme division unit 148 extracts three partial morphemes from the archimorpheme “soccerworldcup (sa(k)/assimilated sound symbol/ka(k)/prolonged sound symbol/wa(k)/prolonged sound symbol/ru(k)/do(k)/ka(k)/assimilated sound symbol/pu(k))”. The detailed description will follow in association with FIG. 7. A document search process is performed based on a morpheme and a partial morpheme that are extracted from text for searching. In the case of “soccerworldcup (“sa/assimilated sound symbol/ka/prolonged sound symbol/wa/prolonged sound symbol/ru/do/ka/assimilated sound symbol/pu”)”, the document search process is performed on four morphemes: “soccerworldcup (“sa/assimilated sound symbol/ka/prolonged sound symbol/wa/prolonged sound symbol/ru/do/ka/assimilated sound symbol/pu”)”; “soccer (sa/assimilated sound symbol/ka/prolonged sound symbol)”; “world (wa/prolonged sound symbol/ru/do);, and “cup (ka/assimilated sound symbol/pu)”. Such a morpheme that serves as a basis for the document search is hereinafter referred to as a “search term”.

The search unit 126 detects a related file candidate base on the order of appearance of a gram contained in a search term (S28). In other words, a document file that contains any of the search terms “soccer (sa/assimilated sound symbol/ka/prolonged sound symbol)”, “world (wa/prolonged sound symbol/ru/do)”, “cup (ka/assimilated sound symbol/pu)”, and “soccerworldcup (“sa/assimilated sound symbol/ka/prolonged sound symbol/wa/prolonged sound symbol/ru/do/ka/assimilated sound symbol/pu”)” is detected as a related file candidate.

The relevance-score calculation unit 128 selects one document file from a group of these related file candidates (S30), performs the relevance score calculation process (S32), and then selects a next document file from the group of related file candidates (Y in S34, S30). Upon the completion of the relevance score calculation process for all the related file candidates (N in S34), the display unit 114, specifying a related file candidate whose relevance score falls within top twenty as a “related document file”, displays a list of a document ID and a relevance score of the related document file on a screen (S36). In the exemplary embodiment, as the relevance score calculation process in S32, two calculation methods are suggested: a first calculation method and a second calculation method. The detailed description will follow in association with FIGS. 8 and 10. Prior to that, the estimate number and the appearance rate on which the first calculation method depends are described in detail.

FIG. 6 is a view that shows the appearance mode of each gram included in an archimorpheme “soccerworldcup (sa/assimilated sound symbol/ka/prolonged sound symbol/wa/prolonged sound symbol/ru/do/ka/assimilated sound symbol/pu)” in a corpus.

The corpus in the exemplary embodiment is a collection of 230 thousand document files. Among these files, the gram “sa/assimilated sound symbol/ka” is detected in 5167 documents according to the index information. The gram “assimilated sound symbol/ka/prolonged sound symbol” is contained in 6312 documents, and the gram “ka/prolonged sound symbol/wa” is contained in only 13 documents. Compared to the gram “assimilated sound symbol/ka/prolonged sound symbol”, the gram “ka/prolonged sound symbol/wa” is the gram of higher rarity.

Among the 5167 documents that contain the gram “sa/assimilated sound symbol/ka”, the position in the morpheme is “beginning” in 4103 documents (about 79%) and “middle” in 1064 documents (about 20%). Statistic information for each gram as shown in the figure is also stored in the index-storing unit 130. When multiple grams of the same type are contained in a document file, the position in the morpheme that is the most common in the grams is collected as the position of the gram in the morpheme in the document file. For example, when a given document file contains three “sa/assimilated sound symbol/ka” grams and the positions of two “sa/assimilated sound symbol/ka” grams in the morpheme are “middle”, the document file is counted as “sa/assimilated sound symbol/ka (middle)” regardless of the position of the remaining “sa/assimilated sound symbol/ka” gram in the morpheme.

In the archimorpheme “soccerworldcup (sa/assimilated sound symbol/ka/prolonged sound symbol/wa/prolonged sound symbol/ru/do/ka/assimilated sound symbol/pu)”, the position of the gram “sa/assimilated sound symbol/ka” in the morpheme is “beginning”, the gram “ka/assimilated sound symbol/pu” is “end”, and the remaining gram is “middle”, respectively. There are nine types of grams that are involved. Among the grams that appear at the same position in the morphemes in document files, the gram contained in the least number of document files is “ka/prolonged sound symbol/wa (middle)”, and the number of the document files is 4. In the corpus, only the document file that contains the gram “ka/prolonged sound symbol/wa (middle)” is likely to contain the morpheme “soccerworldcup (“sa/assimilated sound symbol/ka/prolonged sound symbol/wa/prolonged sound symbol/ru/do/ka/assimilated sound symbol/pu”)”. Thus, the number “4” is the number that indicates the rarity of the morpheme “soccerworldcup (“sa/assimilated sound symbol/ka/prolonged sound symbol/wa/prolonged sound symbol/ru/do/ka/assimilated sound symbol/pu”)”. The estimate-number identification unit 150, based on the position in the morpheme “middle” of the gram “ka/prolonged sound symbol” that is contained in the morpheme “soccerworldcup (sa/assimilated sound symbol/ka/prolonged sound symbol/wa/prolonged sound symbol/ru/do/ka/assimilated sound symbol/pu)” extracted from text for searching, identifies the number “4” of the document files that contain the gram “ka/prolonged sound symbol (middle)” as an estimate number. The smaller the estimate number becomes, the larger the relevance score of the document file that contains the gram “ka/prolonged sound symbol/wa (middle)” and the text for searching becomes. The algorithm will be described in detail in association with FIG. 8.

For a gram contained in the least number of document files, among grams that are contained in morphemes in text for searching and that appear at the same position in morphemes in corpus, the estimate-number identification unit 150 computes the number of the document files as the estimate number. As an exemplary variation, the estimate-number identification unit 150 may compute the estimate number for each gram. For example, the average value of the number of documents such as 4013 for the gram “sa/assimilated sound symbol/ka (beginning)” and 1821 for the gram “assimilated sound symbol/ka/prolonged sound symbol (middle)” may be computed as the estimate number.

Three partial morphemes “soccer (sa/assimilated sound symbol/ka/prolonged sound symbol)”, “world (wa/prolonged sound symbol/ru/do)”, and “cup (ka/assimilated sound symbol/pu)” are extracted from the archimorpheme “soccerworldcup (“sa/assimilated sound symbol/ka/prolonged sound symbol/wa/prolonged sound symbol/ru/do/ka/assimilated sound symbol/pu”)”. From the expression min(4103, 1821), the estimate number for the partial morpheme “soccer (sa/assimilated sound symbol/ka/prolonged sound symbol)” will be 1821. The expression min is a function that returns the minimum value in a group of variables. This is because of the reason that the number of the documents that contain the gram “sa/assimilated sound symbol/ka (beginning)” is 4103 and the number of the documents that contain the gram “assimilated sound symbol/ka/prolonged sound symbol (end)” is 1821. For the same reason, the estimate number of the gram “wa/prolonged sound symbol/ru/do” is 1436 and the estimate number of the gram “ka/assimilated sound symbol/pu” is 310. In other words, the rarity is greater in the order shown as follows: “soccerworldcup (“sa/assimilated sound symbol/ka/prolonged sound symbol/wa/prolonged sound symbol/ru/do/ka/assimilated sound symbol/pu”>“cup (ka/assimilated sound symbol/pu)”>“world (wa/prolonged sound symbol/ru/do)”>“soccer (sa/assimilated sound symbol/ka/prolonged sound symbol)”.

FIG. 7 is a view that shows the appearance mode of each gram contained in the archimorpheme “soccerworldcup (sa/assimilated sound symbol/ka/prolonged sound symbol/wa/prolonged sound symbol/ru/do/ka/assimilated sound symbol/pu)” in a corpus.

Seventy-nine percent of the time (4103/5167), the position of the gram “sa/assimilated sound symbol/ka” in the morpheme is “beginning”. The appearance-rate calculation unit 140 computes the probability of the position of a given gram in a morpheme in the corpus being “beginning” or “beginning-end” as a “rate of appearance at the beginning”. On the other hand, the gram “assimilated sound symbol/ka/prolonged sound symbol” is contained in 6312 documents. Among the documents, the position of the gram in the morpheme is “end” in 4491 documents. The appearance-rate calculation unit 140 computes the probability of the position of a given gram in a morpheme in the corpus being “end” or “beginning-end” as a “rate of appearance at the end”. The rate of appearance of the gram “assimilated sound symbol/ka/prolonged sound symbol” at the end is 71%.

After the extraction of an archimorpheme from text subject to search by the morpheme extraction unit 144 followed by the extraction of gram by the gram extraction unit 146 extracts, the appearance-rate calculation unit 140 calculates both the rate of appearance at the beginning and the rate of appearance at the end for each gram. According to the figure, in the morpheme “soccerworldcup (“sa/assimilated sound symbol/ka/prolonged sound symbol/wa/prolonged sound symbol/ru/do/ka/assimilated sound symbol/pu”)”, the gram “assimilated sound symbol/ka/prolonged sound symbol” is often used at the end of a morpheme, and the gram “wa/prolonged sound symbol/ru” that is located right after the gram “assimilated sound symbol/ka/prolonged sound symbol” in the morpheme “soccerworldcup (“sa/assimilated sound symbol/ka/prolonged sound symbol/wa/prolonged sound symbol/ru/do/ka/assimilated sound symbol/pu”)” is often used at the beginning of a morpheme. In other words, in the morpheme having a sequence of “soccerworldcup (“sa/assimilated sound symbol/ka/prolonged sound symbol/wa/prolonged sound symbol/ru/do/ka/assimilated sound symbol/pu”)”, the assumption can be made that most likely there is a semantic boundary between “soccer (sa/assimilated sound symbol/ka/prolonged sound symbol)” and “worldcup (“wa/prolonged sound symbol/ru/do/ka/assimilated sound symbol/pu”)”. Similarly, most likely there is a semantic boundary between “world (wa/prolonged sound symbol/ru/do)” and “cup (ka/assimilated sound symbol/pu)”.

The morpheme division unit 148 refers to the rate of appearance at the beginning and the rate of the appearance at the end for each gram. When the rate of the appearance of a gram A at the end in a morpheme exceeds a predetermined value, for example, 30% or greater and when the rate of the appearance of a gram B, which is located right after the gram A, at the beginning in a morpheme exceeds a predetermined value, for example, 25% or greater, the morpheme division unit 148 determines that there is a semantic boundary between the gram A and the gram B in the morpheme. Referring back to the previous example, the morpheme division unit 148 extracts three partial morphemes “soccer (sa/assimilated sound symbol/ka/prolonged sound symbol)”, “world (wa/prolonged sound symbol/ru/do)”, and “cup (ka/assimilated sound symbol/pu)” from the archimorpheme “soccerworldcup (“sa/assimilated sound symbol/ka/prolonged sound symbol/wa/prolonged sound symbol/ru/do/ka/assimilated sound symbol/pu”)”. The morpheme division process is performed by such an algorithm.

FIG. 8 is a flowchart that shows the processing process of a first calculation method for a relevance score calculation process in S32 of FIG. 5.

A related file candidate is detected by the search unit 126 for all the search terms contained in the text for searching. A lot of search terms are extracted such as “2006 (2/0/0/6)”, “soccerworldcup (sa/assimilated sound symbol/ka/prolonged sound symbol/wa/prolonged sound symbol/ru/do/ka/assimilated sound symbol/pu)”, and “soccer (sa/assimilated sound symbol/ka/prolonged sound symbol)” from the previously described text for searching “As a team that will win 2006 soccer World Cup (2/0/0/6/nen(c)/no(h)/sa(k)/assimilated sound symbol/ka(k)/prolonged sound symbol/wa(k)/prolonged sound symbol/ru(k)/do(k)/ka(k)/assimilated sound symbol/pu(k)/ni(h)/yu(c)/syo(c)/su(h)/ru(h)/ti(k)/prolonged sound symbol/mu(k)/to(h)/si(h)/te(h))”.

The estimate-number identification unit 150 selects a target search term from at least one search term determined in S28 in FIG. 5 and then determines the estimate number (S42). The appearance-frequency counting unit 152 counts as an appearance frequency the number of times the search term appears in the related file candidate for the search term (S44). The relevance-score calculation unit 128 computes the degree of the relevance of the contents between the search term and the related file candidate as a term score. The relevance-score calculation unit 128 computes the term score by using an arbitrary function whereby the term score increases as the appearance frequency increases and the estimate number decreases (S46). This is based on the idea that the rarer a search term becomes in a corpus and the more the search term appears in a document, the higher the relevance between the document and the search term becomes. The method of evaluating document contents based on the rarity and the appearance frequency of a search term is obtained after following the idea of a TF/IDF (Term Frequency/Inverse Document Frequency) method that has been proven as a search algorithm by a natural language. In the exemplary embodiment, the term score is computed by the following equation:

term score=appearance frequency×(log(1/estimate number)+1)

If there are any search terms left (Y in S48), the relevance-score calculation unit 128 calculates the term score for the search term. Upon the completion of the computation of term scores for all search terms (N in S48), the relevance-score calculation unit 128 computes the sum values and average values of the term scores as relevance scores (S50).

The relevance score calculation process by the first calculation method allows to compute a term score for the document file that contains the same morpheme as a search term contained in text for searching in consideration of the rarity of the search term in a corpus. A term score may not always computed for all search terms. For example, elimination of a morpheme of one letter from the computation of a term score speeds up the process of the relevance score calculation. The maximum value and the minimum value of multiple term scores may be specified as relevance scores instead.

The detailed description will follow regarding the relevance score calculation process by the second calculation method. Prior to that, a first occurrence count, a second occurrence count, a phrase probability, a weighting factor, and an intermediate value on which the second calculation method depends are described in detail.

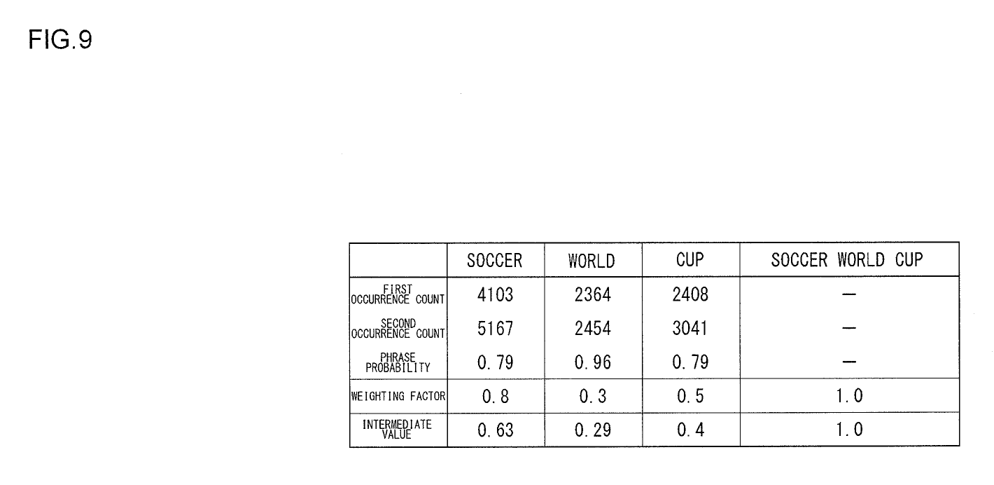

FIG. 9 is a view that shows the relation between the phrase probability of each partial morpheme contained in the archimorpheme “soccerworldcup (sa/assimilated sound symbol/ka/prolonged sound symbol/wa/prolonged sound symbol/ru/do/ka/assimilated sound symbol/pu)” and the intermediate value.

The way of evaluating the first occurrence count shown in the figure is similar to the way of evaluating the estimate number. For example, in the partial morpheme “world (wa/prolonged sound symbol/ru/do)” and the archimorpheme “soccerworldcup (sa/assimilated sound symbol/ka/prolonged sound symbol/wa/prolonged sound symbol/ru/do/ka/assimilated sound symbol/pu)”, the position of the gram “wa/prolonged sound symbol/ru” in the morpheme is “beginning” or “middle” and the position of the gram “prolonged sound symbol/ru/do” in the morpheme is “end” or “middle”. The first occurrence count of the partial morpheme “world (wa/prolonged sound symbol/ru/do)” is computed as follows:

first occurrence count=min(the number of documents that contain “wa/prolonged sound symbol/ru (beginning)” or “wa/prolonged sound symbol/ru (middle)”, the number of documents that contain “prolonged sound symbol/ru/do (middle)” or “prolonged sound symbol/ru/do (end)” According to the data shown in FIG. 6, the first occurrence count of “world (wa/prolonged sound symbol/ru/do)” is 2364 from the expression min(1835+529, 1436+2561).

The first occurrence count represents “the number of the document files where it is assumed that a given morpheme A is used in the proper sense of the word in the document files”. For example, a partial morpheme “plus (note that the text is rendered in Japanese as “pu(k)/ra(k)/su(k)”)” may be detected as a part of a morpheme “Laplace (note that the text is rendered in Japanese as “ra(k)/pu(k)/ra(k)/su(k)”)” or as a part of a morpheme “plastics (note that the text is rendered in Japanese as “pu(k)/ra(k)/su(k)/ti(k)/assimilated sound symbol/ku(k)“)”. The first occurrence count is a numerical value for identifying the number of document files after removing the document files where a character string that indicates a partial morpheme forms a morpheme that has different meaning from a group of document files that contain the partial morpheme. From the expression min(4103, 4491+1821), the first occurrence count of the partial morpheme “soccer (sa/assimilated sound symbol/ka/prolonged sound symbol)” is will be 4103, and from 2098+310, the first occurrence count of the partial morpheme “cup (ka/assimilated sound symbol/pu)” will be 2408. As described, the first occurrence count is identified based on the number of a document file where the position of a gram in a morpheme such as an archimorpheme and a partial morpheme matches the position of the gram in the morpheme in the document file.

The second occurrence count is identified regardless of the notational consistency. For example, the second occurrence count of the morpheme “world (wa/prolonged sound symbol/ru/do)” will be 2454 from the expression min(the number of documents that contain “wa/prolonged sound symbol/ru” (2454), the number of documents that contain “prolonged sound symbol/ru/do” (3997)). The second occurrence count is identified based on the number of document files that contain a gram in a partial morpheme.

In performing the relevance score calculation process in S32 in FIG. 5 by the second calculation method, the phrase-probability calculation unit 142 computes the phrase probability from (the first occurrence count)/(the second occurrence count). In the figure, the phrase probability of “wa/prolonged sound symbol/ru/do” is obtained as follows: 2364/2454=0.96 The phrase probability is a numerical value that indicates “the probability of a morpheme being used in the proper sense of the word in the group of document files that contain the morpheme as a character string”. In the case of the exemplary embodiment, the phrase probabilities of “soccer (sa/assimilated sound symbol/ka/prolonged sound symbol)”, “world (wa/prolonged sound/ru/do)”, and “cup (ka/assimilated sound symbol/pu)” are 0.79, 0.96, and 0.79, respectively. It is found that the probability of the partial morpheme “world (wa/prolonged sound/ru/do)” being used in the proper sense of the word in a corpus is high at 96%. In other words, contrary to the partial morpheme “plus (pu(k)/ra(k)/su(k)” that is shown earlier, it is found that the partial morpheme “world (wa/prolonged sound/ru/do)” is a highly independent term that is hardly integrated as a part of other morpheme. In a document file that contains a character string “plus (pu(k)/ra(k)/su(k)”, “plus (pu(k)/ra(k)/su(k))” may be used in a different meaning such as in “Laplace (ra(k)/pu(k)/ra(k)/su(k)” and “plastics (pu(k)/ra(k)/su(k)/ti(k)/assimilated sound symbol/ku(k)). On the other hand, in a document file that contains a character string “world (wa/prolonged symbol/ru/do)”, the probability of “world (wa/prolonged sound/ru/do)” being used in the proper sense of the word is high. In the second calculation method, the term score for a highly independent search term such as “world (wa/prolonged sound symbol/ru/do)” is highly weighted.

It is found that among the partial morphemes “soccer (sa/assimilated sound symbol/ka/prolonged sound symbol)”, “world (wa/prolonged sound symbol/ru/do)”, and “cup (ka/assimilated sound symbol/pu)”, the most significant partial morpheme for the term “soccerworldcup (sa/assimilated sound symbol/ka/prolonged sound symbol/wa/prolonged sound symbol/ru/do/ka/assimilated sound symbol/pu)” is “soccer (sa/assimilated sound symbol/ka/prolonged sound symbol)”. This is based on the empirical rule stating that in a term that is represented by a long character string, the meaning of the term is often indicated at the beginning part of the term. For example, in the case of an archimorpheme “Tokushima-prefecture (note that it is rendered in Japanese as “toku(c)/sima(c)/ken(c)”)”, the partial morpheme “Tokushima (toku(c)/sima(c))” located at the beginning of the archimorpheme indicate the characteristics of the archimorpheme more than the partial morpheme “prefecture (ken(c))” does. In the second calculation method, the term score of a partial morpheme that is located at the beginning of a morpheme such as the partial morpheme “soccer (sa/assimilated sound symbol/ka/prolonged sound symbol)” is weighted higher than that of other partial morphemes. In the research conducted by the inventors, when weighting a partial morpheme at the beginning, a partial morpheme in the middle, and a partial morpheme at the end of an archimorpheme at a ratio of 8:3:5, the recall (indicating how low the drop out is) and the precision (indicating how low the mis-hit is) both reach the optimal values. Accordingly, in the second calculation method of the exemplary embodiment, weighting factors are set as beginning: 0.8, middle: 0.3, and end: 0.5, and the relevance-score calculation unit 128 computes an intermediate value for a respective search term as follows:

intermediate value=phrase probability×weighting factor

The intermediate value is a numerical value of 1 or less and indicates the degree of independence as a search term and the degree of importance in text for searching. The intermediate value of an archimorpheme such as “soccerworldcup (sa/assimilated sound symbol/ka/prolonged sound symbol/wa/prolonged sound symbol/ru/do/ka/assimilated sound symbol/pu)” is fixed to “1”. In the second calculation method, a relevance-score is computed based on the intermediate value.

FIG. 10 is a flowchart that shows the processing process of the second calculation method for the relevance score calculation process in S32 of FIG. 5.

The phrase-probability calculation unit 142 selects a search term (S60) and computes a phrase probability (S62). The relevance-score calculation unit 128 computes the intermediate value of the search term by using the equation shown above (S64). The relevance-score calculation unit 128 counts the appearance frequency of the search term in a related file candidate and computes a term score by using an arbitrary function where the term score increases as the appearance frequency and the intermediate value increase (S66). This is based on the idea that the higher the probability of a morpheme being used in the proper sense of the word becomes, and in case of a partial morpheme, the more important position the partial morpheme is located and the more its search term appears in a document, the higher the relevance between the content of the document file and that of the text for searching becomes. In the exemplary embodiment, the term score is computed by the following equation:

term score=intermediate value×appearance frequency

In a developed example, the term score may be adjusted based on the position of the search term in the morpheme of the related file candidate. For example, when the search term is “Kyoto (note that it is rendered in Japanese as “kyo(c)/to(c)”)”, the document file that contains morphemes “Kyoko (kyo(c)/to(c))”, “Kyoto-prefecture (note that it is rendered in three letters in Japanese “kyo(c)/to(c)/fu(c)”)”, “Tokyo-prefecture (note that it is rendered in three letters in Japanese “to(c)/kyo(c)/to(c)”)”, or “operated by Tokyo Metropolitan Government (note that it is rendered in four letters in Japanese “to(c)/kyo(c)/to(c)/ei(c)”)” is detected as a related file candidate. However, aside from “Kyoto (kyo(c)/to(c))” that matches perfectly and “Kyoto-prefecture (kyo(c)/to(c)/fu(c))” that matches at the beginning, “Tokyo-prefecture (to(c)/kyo(c)/to(c))” that matches at the end and “operated by Tokyo Metropolitan Government (to(c)/kyo(c)/to(c)/ei(c))” that matches partially may match the search term “Kyoto (kyo(c)/to(c))” in terms of the character string but the relevance is low in terms of the contents. Thus, an adjustment factor is set in accordance with the way a morpheme and a search term match each other in a document file. Specifically, the setting is made as follows: a perfect match: 1.0, a match at the beginning: 0.6, a partial match: 0.2, and a match at the end: 0.5. In this case, the term score is computed by the following equation:

term score=intermediate value×Σ(adjustment factor)

The term Σ(adjustment factor) means computing the sum of the adjustment factors for all search terms contained in a related file candidate.

For example, it is assumed that three character strings “Kyoto (kyo(c)/to(c))” are detected in a given document file, showing a perfect match, a match at the beginning, and a partial match, respectively. If the intermediate value is 0.6, the equation is as follows:

term score=0.6×(1.0+0.6+0.2)=1.08

Such a calculation method allows for the computation of the term score where both the way the search term matches and the appearance frequency thereof in the related file candidate are taken into account.

If there are any search terms left (Y in S68), the relevance-score calculation unit 128 calculates the term score for the search term. Upon the completion of the computation of term scores for all search terms detected from the text for searching (N in S68), the relevance-score calculation unit 128 computes the sum values of the term scores as relevance scores.

The relevance score calculation process by the second calculation method allows computing the term score where the importance of the search term and the appearance frequency in the document file are taken into consideration. Similar to the first calculation method, a term score may not always computed for all search terms.

The idea of the phrase probability, the weighting factor, and the adjustment factor in the second calculation method can be applied to the first calculation method. For example, in the first calculation method, the term score may be computed as follows:

term score=Σ(adjustment factor)×(log(1/estimate number)+1) A

term score=Σ(intermediate value)×(log(1/estimate number)+1) B

term score=Σ(intermediate valuexadjustment factor)×(log(1/estimate number)+1) C

The document search apparatus 100 described in the exemplary embodiment improves, in both the first calculation method and the second calculation method, both the recall and the precision compared to the document search process based only on the morphological analysis. In the morphological analysis, the accuracy of the document search depends on the kind of semantic unit that is used for the extraction of a morpheme. In the case of the document search apparatus 100 in the exemplary embodiment, a partial morpheme can be reasonably extracted from an archimorpheme by using the rate of appearance at the beginning and the rate of appearance at the end. Since not only an archimorpheme but also a partial morpheme are subject to the computation of the relevance score as a search term, the ambiguity and the arbitrariness, questioning “what kind of semantic unit should be used for the extraction of a morpheme”, can be reasonably resolved.

A corpus where “general education (note that it is rendered in Japanese as “i(c)/pan(c)/kyo(c)/yo(c)/ka(c)/tei(c)”)” is often used in an abbreviated form “GE (note that it is rendered in Japanese as “pan(c)/kyo(c)”)” is given as an example. In the conventional morphological analysis, it is difficult to extract the slang morpheme “GE (pan(c)/kyo(c))” from the morpheme “general education (i(c)/pan(c)/kyo(c)/yo(c)/ka(c)/tei(c))”. However, the document search apparatus 100 in the exemplary embodiment can extract a term “GE (pan(c)/kyo(c))” as a morpheme having a meaning by using the rate of appearance at the beginning and the rate of appearance at the end. This allows for easier extraction of the partial morpheme “GE (pan(c)/kyo(c))” by the morpheme division unit 148 from the archimorpheme “general education (i(c)/pan(c)/kyo(c)/yo(c)/ka(c)/tei(c))”, when text for searching that contains the archimorpheme is entered. Therefore, with regard to the relevance score calculation, consideration can be given to the morphemes “general education (i(c)/pan(c)/kyo(c)/yo(c)/ka(c)/tei(c))” and “GE (pan(c)/kyo(c))” that are different in terms of the character string but are in close relation with each other in terms of the meaning. The morpheme breaking down process contributes to the improvement of the accuracy in the document search.

In the first calculation method, the degree of rarity of a search term in a corpus is indexed by an estimate number. In order to accurately count the number of documents that contain the character string “soccerworldcup (sa/assimilated sound symbol/ka/prolonged sound symbol/wa/prolonged sound symbol/ru/do/ka/assimilated sound symbol/pu)”, a process for detecting a document file where eleven letters (when rendered in Japanese) “soccerworldcup (sa/assimilated sound symbol/ka/prolonged sound symbol/wa/prolonged sound symbol/ru/do/ka/assimilated sound symbol/pu)” are lined up, by referring to index information, is necessary. On the other hand, compiling the data shown in FIG. 6 from index information in advance allows for easier indexing of the rarity of a given morpheme by the estimate-number identification unit 150. Although the estimate number is not a numerical value that exactly indicates the rarity of a morpheme, the estimate number can be effectively used as a numerical value that approximately indicates the rarity.

In the second calculation method, the degree of independence of a search term is indexed by the phrase probability. Even when the morpheme of text for searching and the morpheme of a document file match each other as character strings, the possibility of the morphemes being used in different meanings can be taken into consideration. Furthermore, for example, the position of a partial morpheme in an archimorpheme and the appearance mode of a search term in a document file can be taken into consideration using the weighting factor and the adjustment factor. Therefore, the accuracy of the document search can be further improved.

Described above is an explanation based on the embodiments of the present invention. These embodiments are intended to be illustrative only and it will be obvious to those skilled in the art that various modifications to constituting elements and processes could be developed and that such modifications are also within the scope of the present invention.

A “morpheme for searching” described in the claims is represented by both the archimorpheme and the partial morpheme in the exemplary embodiment or by either one of them. A “gram for identification” described in the claims is represented by “ka/prolonged sound symbol/wa” in the exemplary embodiment.

Therefore, it will be obvious to those skilled in the art that the function to be achieved by each constituent requirement described in the claims may be achieved by each functional block shown in the exemplary embodiments or by a combination of the functional blocks.

### INDUSTRIAL APPLICABILITY

The present invention provides document search based on a natural language with improved accuracy.

1. A document search apparatus for searching among a group of a predetermined document file for a document file that is highly related to text for searching in terms of contents comprising:
an index-storing unit operative to store index information of a gram, which is a character string of a predetermined number of letters, a document ID of a document file that contains the gram, and the position of the gram in a morpheme of the document file in association with each gram contained in a group of the predetermined document file;
a text-for-searching acquisition unit operative to receive the input of text for searching;
a morpheme extraction unit operative to extract at least one morpheme for searching from text for searching;
a gram extraction unit operative to extract at least one gram from a morpheme for searching;
an estimate-number identification unit operative to identify, by referring to index information, the number of a document file in which the position of a gram for identification in a morpheme for searching matches the position of the gram for identification in a morpheme of a document file as an estimate number of a document file that contains the morpheme for searching;
a document search unit operative to detect, by referring to index information, a document file in which the order of appearance of at least one gram contained in the morpheme for searching matches the order of appearance of at least one gram in a morpheme of a document file;
an appearance-frequency counting unit operative to count the number of times at least one gram, which has the matching order of appearance, appears in the detected document file as an appearance frequency; and
a relevance-score calculation unit operative to index, from the appearance frequency and the estimate number regarding the morpheme for searching, the relevance of the contents between the text for searching and the detected document file as a relevance score.

2. The document search apparatus according to claim 1 wherein the position of a gram in a morpheme is information that indicates which one of a leading part, an ending part, or a middle part, which constitute a part of the remaining part, of the morpheme the gram is located.

3. The document search apparatus according to claim 1 wherein the relevance-score calculation unit is operative to compute a relevance score so that as the appearance frequency increases and the estimate number decreases, the relevance between the detected document file and the text for searching increases.

4. The document search apparatus according to of claim 1 further comprising:
an appearance-rate calculation unit operative to compute a rate of appearance at the beginning and a rate of appearance at the end wherein the ratio of the number of a document file that contains a gram to be searched for at the leading part of a morpheme and the total number of a document file that contains the gram to be searched for is defined as the rate of appearance at the beginning and wherein the ratio of the number of a document file that contains a gram to be searched for at the ending part of a morpheme and the total number of a document file that contains the gram to be searched for is defined as the rate of appearance at the end; and
a morpheme division unit operative, based on the rates of appearance at the beginning and the rates of appearance at the end of a plurality of grams contained in a morpheme for searching, to further divide the morpheme for searching into a plurality of morphemes for searching.

5. The document search apparatus according to claim 4 wherein the morpheme division unit is operative to divide, when the rate of appearance of a first gram, which is contained in a morpheme for searching, at the end is at least a predetermined value and when the rate of appearance of a second gram, which is posteriorly adjacent to the first gram, at the beginning is at least a predetermined value in the morpheme for searching, the morpheme for searching at the border of the first gram and the second gram.

6. The document search apparatus according to claim 1 wherein the relevance-score calculation unit is operative to compute a relevance score from the appearance frequency and the estimate number that are identified for each of a plurality of morphemes for searching contained in text for searching.

7. The document search apparatus according to claim 1 wherein the estimate-number identification unit is operative, among a gram contained in the morpheme for searching, to identify a gram obtained when the number of the matching document file is the least as the gram for identification and to identify the number of the document file as an estimate number for the morpheme for searching.

8. The document search apparatus according to claim 1 wherein the index-storing unit is operative to store index information for a gram whose number of letters changes in accordance with a letter type.

9. A document search method for searching among a group of a predetermined document file for a document file having high relevance in terms of content to text for searching comprising:
acquiring index information of a gram, which is a character string of a predetermined number of letters, a document ID of a document file that contains the gram, and the position of the gram in a morpheme of the document file in association with each gram contained in a group of the predetermined document file;
receiving the input of text for searching;
extracting at least one morpheme for searching from text for searching;
extracting at least one gram from a morpheme for searching;
identifying, by referring to index information, the number of a document file in which the position of a gram for identification in a morpheme for searching matches the position of the gram for identification in a morpheme of a document file as an estimate number of a document file that contains the morpheme for searching;
detecting, by referring to index information, a document file in which the order of appearance of at least one gram contained in the morpheme for searching matches the order of appearance of at least one gram in a morpheme of a document file;
counting the number of times at least one gram, which has the matching order of appearance, appears in the detected document file as an appearance frequency; and
indexing, from the appearance frequency and the estimate number regarding the morpheme for searching, the relevance of the contents between the text for searching and the detected document file as a relevance score.

10. A document search program of a computer for searching a group of a predetermined document file for a document file having high relevance in terms of content to text for searching comprising:
a module that stores index information of a gram, which is a character string of a predetermined number of letters, a document ID of a document file that contains the gram, and the position of the gram in a morpheme of the document file in association with each gram contained in a group of the predetermined document file;
a module that receives the input of text for searching;
a module that extracts at least one morpheme for searching from text for searching;
a module that extracts at least one gram from a morpheme for searching;
a module that identifies, by referring to index information, the number of a document file in which the position of a gram for identification in a morpheme for searching matches the position of the gram for identification in a morpheme of a document file as an estimate number of a document file that contains the morpheme for searching;
a module that detects, by referring to index information, a document file in which the order of appearance of at least one gram contained in the morpheme for searching matches the order of appearance of at least one gram in a morpheme of a document file;
a module that counts the number of times at least one gram, which has the matching order of appearance, appears in the detected document file as an appearance frequency; and
a module that indexes, from the appearance frequency and the estimate number regarding the morpheme for searching, the relevance of the contents between the text for searching and the detected document file as a relevance score.

11. A document search apparatus for searching a group of a predetermined document file for a document file having high relevance in terms of content to text for searching comprising:
an index-storing unit operative to store index information of a gram, which is a character string of a predetermined number of letters, a document ID of a document file that contains the gram, and the position of the gram in a morpheme of the document file in association with each gram contained in a group of the predetermined document file;
a text-for-searching acquisition unit operative to receive the input of text for searching;
a morpheme extraction unit operative to extract at least one morpheme for searching from text for searching;
a gram extraction unit operative to extract at least one gram from a morpheme for searching;
an appearance-rate calculation unit operative to compute, by referring to index information, a rate of appearance at the beginning and a rate of appearance at the end wherein the ratio of the number of a document file that contains a gram to be searched for at the leading part of a morpheme and the total number of a document file that contains the gram to be searched for is defined as the rate of appearance at the beginning and wherein the ratio of the number of a document file that contains a gram to be searched for at the ending part of a morpheme and the total number of a document file that contains the gram to be searched for is defined as the rate of appearance at the end;
a morpheme division unit operative, from the rates of appearance at the beginning and the rates of appearance at the end of a plurality of grams contained in a given morpheme for searching, to divide the morpheme for searching into a plurality of partial morphemes for searching;
a document search unit operative to detect, by referring to index information, a document file in which the order of appearance of at least one gram contained in a given partial morpheme matches the order of appearance of at least one gram in a morpheme in a document file;
an appearance-frequency counting unit operative to count the number of times at least one gram, which has the matching order of appearance, appears in the detected document file as an appearance frequency; and
a relevance-score calculation unit operative to index, from a weighting coefficient according to the appearance frequency counted for the partial morpheme and the position of the partial morpheme in the morpheme for searching, the relevance in terms of content between the text for searching and the document file as a relevance score.

12. The document search apparatus according to claim 11 wherein the position of a partial morpheme in a morpheme for searching is information that indicates which one of a leading part, an ending part, or a middle part, which constitute a part of the remaining part, of the morpheme for searching the partial morpheme is located.

13. The document search apparatus according to claim 11 wherein the morpheme division unit is operative to divide, when the rate of appearance of a first gram, which is contained in a morpheme for searching, at the end is at least a predetermined value and when the rate of appearance of a second gram, which is posteriorly adjacent to the first gram, at the beginning is at least a predetermined value in the morpheme for searching, the morpheme for searching at the border of the first gram and the second gram.

14. The document search apparatus according to claim 11 wherein the relevance-score calculation unit is operative to compute a relevance score from the appearance frequency and the weighting coefficient that are identified for each of a plurality of partial morphemes contained in text for searching.

15. The document search apparatus according to claim 11 wherein the relevance-score calculation unit is operative to set a weighting coefficient so that a partial morpheme at the leading part of a morpheme for searching has more effect on a relevance score than a partial morpheme located at other part of the morpheme for searching does.

16. The document search apparatus according to claim 11 further comprising:
when a first occurrence count is equal to the number of a document file in which the position of a gram in a partial morpheme matches the position of the gram in a morpheme of a document file, and
when a second occurrence count is equal to the number of a document file containing a gram contained in the partial morpheme,
a phrase-probability calculation unit operative to compute as phrase probability, from the first occurrence count and the second occurrence count, the ratio of the partial morpheme being used in the proper sense of the word in the group of the predetermined document file,
wherein the relevance-score calculation unit calculates a relevance score from the phrase probability of the partial morpheme, the weighting coefficient, and the appearance frequency of the partial morpheme.

17. The document search apparatus according to claim 11 wherein
the morpheme extraction unit extracts a morpheme also from the detected document file, and
the relevance-score calculation unit adjusts a relevance score from the positional relation of the detected morpheme in the document file and a partial morpheme contained in the morpheme.

18. The document search apparatus according to claim 17 wherein the relevance-score calculation unit adjusts a relevance score so that in the detected document file, the relevance becomes higher when the partial morpheme is detected at the leading part of a morpheme than when the partial morpheme is detected at the other part of the morpheme.

19. A document search method for searching a group of a predetermined document file for a document file having high relevance in terms of content to text for searching comprising:
acquiring index information of a gram, which is a character string of a predetermined number of letters, a document ID of a document file that contains the gram, and the position of the gram in a morpheme of the document file in association with each gram contained in a group of the predetermined document file;
receiving the input of text for searching;
extracting at least one morpheme for searching from text for searching;
extracting at least one gram from a morpheme for searching;
computing, by referring to index information, a rate of appearance at the beginning and a rate of appearance at the end wherein the ratio of the number of a document file that contains a gram to be searched for at the leading part of a morpheme and the total number of a document file that contains the gram to be searched for is defined as the rate of appearance at the beginning and wherein the ratio of the number of a document file that contains a gram to be searched for at the ending part of a morpheme and the total number of a document file that contains the gram to be searched for is defined as the rate of appearance at the end;
dividing, from the rates of appearance at the beginning and the rates of appearance at the end of a plurality of grams contained in a given morpheme for searching, the morpheme for searching into a plurality of morphemes for searching;
detecting, by referring to index information, a document file in which the order of appearance of at least one gram contained in a given partial morpheme matches the order of appearance of at least one gram in a morpheme in a document file;
counting the number of times at least one gram, which has the matching order of appearance, appears in the detected document file as an appearance frequency; and
indexing, from a weighting coefficient according to the appearance frequency counted for the partial morpheme and the position of the partial morpheme in the morpheme for searching, the relevance in terms of content between the text for searching and the document file as a relevance score.

20. A document search program of a computer for searching a group of a predetermined document file for a document file having high relevance in terms of content to text for searching comprising:
a module that stores index information of a gram, which is a character string of a predetermined number of letters, a document ID of a document file that contains the gram, and the position of the gram in a morpheme of the document file in association with each gram contained in a group of the predetermined document file;
a module that receives the input of text for searching;
a module that extracts at least one morpheme for searching from text for searching;
a module that extracts at least one gram from a morpheme for searching;
a module that computes, by referring to index information, a rate of appearance at the beginning and a rate of appearance at the end wherein the ratio of the number of a document file that contains a gram to be searched for at the leading part of a morpheme and the total number of a document file that contains the gram to be searched for is defined as the rate of appearance at the beginning and wherein the ratio of the number of a document file that contains a gram to be searched for at the ending part of a morpheme and the total number of a document file that contains the gram to be searched for is defined as the rate of appearance at the end;
a module that divides, from the rates of appearance at the beginning and the rates of appearance at the end of a plurality of grams contained in a given morpheme for searching, the morpheme for searching into a plurality of morphemes for searching;
a module that detects, by referring to index information, a document file in which the order of appearance of at least one gram contained in a given partial morpheme matches the order of appearance of at least one gram in a morpheme in a document file;
a module that counts the number of times at least one gram, which has the matching order of appearance, appears in the detected document file as an appearance frequency; and
a module that indexes, from a weighting coefficient according to the appearance frequency counted for the partial morpheme and the position of the partial morpheme in the morpheme for searching, the relevance in terms of content between the text for searching and the document file as a relevance score.
